(19) United States
(12) Patent Application Publication
(10) Pub. No.: US 2021/0339642 A1
(43) Pub. Date: Nov. 4, 2021

(54) APPARATUS FOR AUTOMATICALLY CHARGING VEHICLE IN UNMANNED INTELLIGENT PARKING DEVICE

(71) Applicant: Hangzhou Dazhong Boao Technology Co., Ltd., Hangzhou (CN)

(72) Inventors: Yanzheng WU, Hangzhou (CN); Shuilong ZHENG, Hangzhou (CN); Qingling FANG, Hangzhou (CN); Jiahong WANG, Hangzhou (CN); Kai ZHANG, Hangzhou (CN)

(73) Assignee: Hangzhou Dazhong Boao Technology Co., Ltd.

(21) Appl. No.: 17/373,752

(22) Filed: Jul. 12, 2021

(30) Foreign Application Priority Data
Feb. 8, 2021 (CN) 202110187017.2

(51) Int. Cl. B60L 53/35; B60L 53/18; B60L 53/16

(52) U.S. Cl. CPC B60L 53/35; B60L 53/16; B60L 53/18

(57) ABSTRACT

The present invention relates to an apparatus for automatically charging a vehicle in an unmanned intelligent parking device, which is applied to various unmanned parking devices in need of a charging function. The apparatus includes a carrier fora parking device, the carrier being provided with a lifting component and a traveling component, where the apparatus further includes a charging docking apparatus, a charging adapter, a storage location charging fixing seat and a storage location power pickup apparatus, the storage location charging fixing seat is arranged in a parking space of the parking device, the carrier is provided with the charging docking apparatus, the storage location power pickup apparatus is mounted on the storage location charging fixing seat, and the charging adapter is switched to the storage location charging fixing seat through the charging docking apparatus and electrically connected to the storage location power pickup apparatus.

### TECHNICAL FIELD

The present invention relates to an apparatus for automatically charging a vehicle in an unmanned intelligent parking device, which is applied to various unmanned parking devices in need of a charging function, so as to charge to new energy vehicles parked in mechanical garages.

### BACKGROUND

There are more and more new energy rechargeable vehicles, and new parking lots are substantially required to provide a certain proportion, of charging parking spaces. As a ground parking space or a lifting and horizontally-moving type parking device is relatively simple, a driver directly can charge a vehicle parked in the parking space. However, when an unmanned intelligent garage is used, drivers only need to park vehicles at an entrance, and a carrier automatically carries the vehicles to parking, spaces on different floors. Consequently, the drivers cannot charge the vehicles at the parking spaces.

### SUMMARY

The present invention is intended to solve the above-mentioned problems existing in the prior art, and aims to provide an apparatus for automatically charging a vehicle in an unmanned intelligent parking device to solve a vehicle charging problem.

The technical solutions adopted in the present invention are as follows:

An apparatus for automatically charging a vehicle in an unmanned intelligent parking device includes a carrier for a parking device, the carrier being provided with a lifting component and a traveling component; the apparatus further includes a charging docking apparatus, a charging adapter, a storage location charging fixing seat and a storage location power pickup apparatus; the storage location charging fixing seat is arranged in a parking space of the parking device, the carrier is provided with the charging docking apparatus, the storage location power pickup apparatus is mounted on the storage location charging fixing seat, and the charging adapter is switched to the storage location charging fixing seat through the charging docking apparatus and electrically connected to the storage location power pickup apparatus.

Preferably, the charging adapter includes a brush collector, a cable, a charging socket and a mounting base; the brush collector and the charging socket are arranged on the mounting base, and the cable is configured to connect the brush collector to the charging socket.

Preferably, the storage location charging fixing seat includes a horizontal positioning pin and a fool-proof pin that are mounted on a guide base, and the fool-proof pin is eccentrically arranged; and the horizontal positioning pin is inserted into the charging adapter and configured to position the charging adapter.

Preferably, the charging adapter is further provided with a horizontal spring thrust shaft, and the horizontal spring thrust shaft is configured to clamp the fool-proof pin.

Preferably, the charging docking apparatus includes a fixed outer frame, a rotating inner frame and a vertical positioning pin that are mounted on the carrier; a tail of the rotating inner frame is connected to the fixed outer frame through a rotating bearing set, a head thereof is provided with a universal bovine eye, a positioning guide wheel group and the vertical positioning pin, and the universal bovine eye longitudinally positions the rotating inner frame in the guide base; and the positioning guide wheel group is in contact with the charging adapter and configured to longitudinally position the charging adapter and the vertical positioning pin.

Preferably, the apparatus for automatically charging a vehicle in an unmanned intelligent parking device further includes a stopping screw and a guide spring, where the stopping screw and the guide spring are arranged between the fixed outer frame and the rotating inner frame.

Preferably, the storage location power pickup apparatus includes a collector mounting base, and a collector rail seeker, a collector rail and a power cord that are mounted on the collector mounting base.

Preferably, the charging adapter is further provided with a vertical spring thrust shaft, and the vertical spring thrust shaft clamps the vertical positioning pin, so that the charging docking apparatus vertically positions the charging adapter.

Preferably, the vertical positioning pin pushes the horizontal spring thrust shaft to be separated from the fool-proof pin, so that the charging adapter is separated from the storage location charging fixing seat.

Preferably, a waterproof cover is arranged outside a cable connection position of the charging adapter; and a tail of the horizontal positioning pin is, provided with a compression spring and an adjusting nut.

Compared with the prior art, the present invention has the following beneficial effects:

The product is a novel apparatus for automatically charging a vehicle in a parking device. It is designed on the basis of an existing parking device, and enables a vehicle to be automatically charged in a parking space after the vehicle is transported by a carrier.

The product is a novel apparatus for automatically charging a new energy vehicle parked at a mechanical storage location in an unmanned intelligent parking device. It is designed based on an existing unmanned intelligent parking device, and enables a vehicle to be automatically charged in a parking space after the vehicle is transported to the mechanical storage location by a carrier.

### BRIEF DESCRIPTION OF DRAWINGS

FIG. 1 is a schematic structural diagram of a product according, to the present invention;

FIG. 2 is a schematic structural diagram of a charging adapter of a product according to the present invention;

FIG. 3 is a right view of FIG. 2;

FIG. 4 is a schematic structural diagram of a storage location charging fixing seat of a product according to the present invention;

FIG. 5 is a top view of FIG. 4;

FIG. 6 is a schematic structural diagram of a charging docking apparatus of a product according to the present invention;

FIG. 7 is a top view of FIG. 6;

FIG. 8 is a schematic structural diagram of a storage location power pickup apparatus of a product according to the present invention;

FIG. 9 is a top view of FIG. 8;

FIG. 10 is a working flowchart 1 of a product according to the present invention;

FIG. 11 is a working flowchart 2 of a product according to the present invention;

FIG. 12 is a working flowchart 3 of a product according to the present invention;

FIG. 13 is a sectional view of FIG. 12 along B-B;

FIG. 14 is a working flowchart 4 of a product according to the present invention;

FIG. 15 is a working flowchart 5 of a product according to the present invention;

FIG. 16 is a working flowchart 6 of a product according to the present invention;

FIG. 17 is a working flowchart 7 of a product according to the present invention;

FIG. 18 is a working flowchart 8 of a product according to the present invention;

FIG. 19 is a working flowchart 9 of a product according to the present invention; and

FIG. 20 is a working flowchart 10 of a product according to the present invention.

Description of reference numerals: carrier 1, lifting component 2, traveling component 3, charging docking apparatus 4, fixed outer frame 41, rotating inner frame 42, vertical positioning pin 43, rotating bearing set 44, universal bovine eye 45, positioning guide wheel group 46, stopping screw 47, guide spring 48, charging adapter 5, brush collector 51, cable 52, charging socket 53, mounting base 54, horizontal spring thrust shaft 55, vertical spring thrust shaft 56, waterproof cover 57, storage location charging fixing seat 6, guide base 61, horizontal positioning pin 62, fool-proof pin 63, compression spring 64, adjusting nut 65, storage location power pickup apparatus 7, collector mounting base 71, collector rail seeker 72, collector rail 73, power cord 74, and charging gun 8.

### DESCRIPTION OF EMBODIMENTS

The present invention will be further described in detail below with reference to accompanying drawings and specific implementations.

Design description: A carrier 1, a lifting component 2 and a traveling component 3 in an embodiment pertain to the prior art. This embodiment does not involve improvements to the above-mentioned components, and thus working principles thereof will not be described in detail.

### Embodiment:

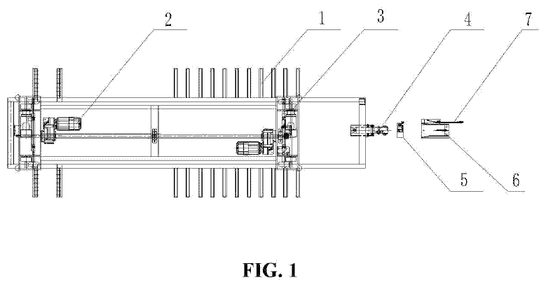

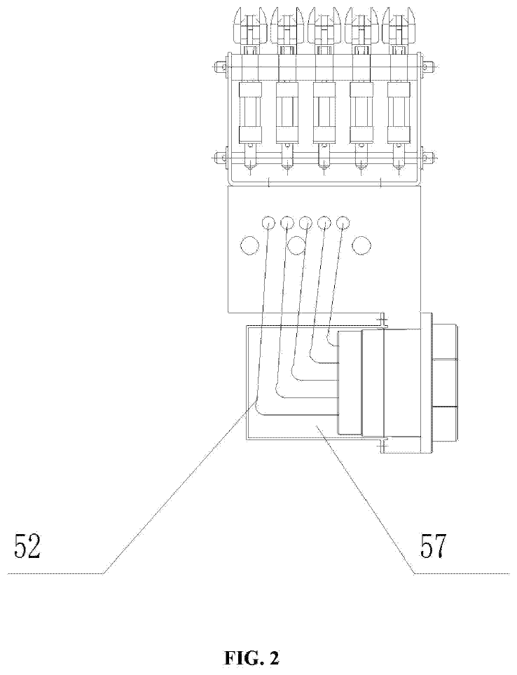

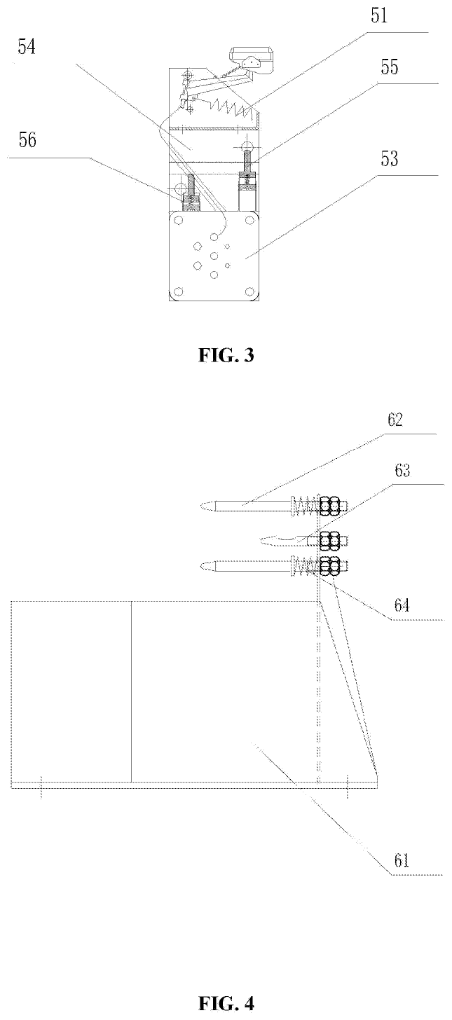

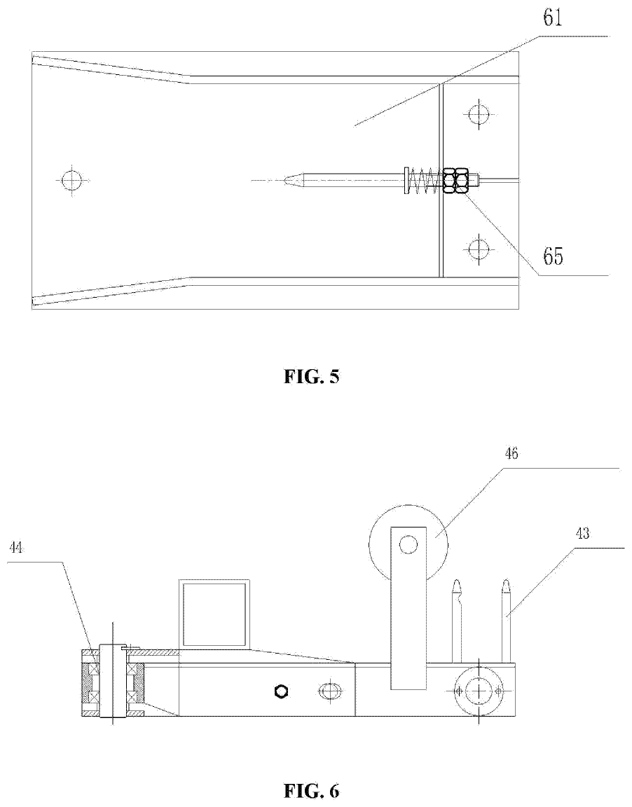

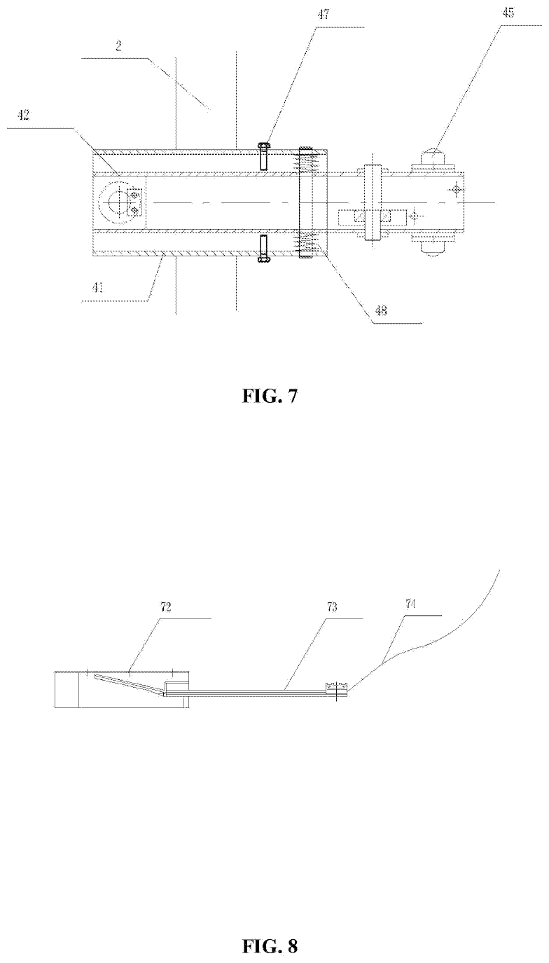

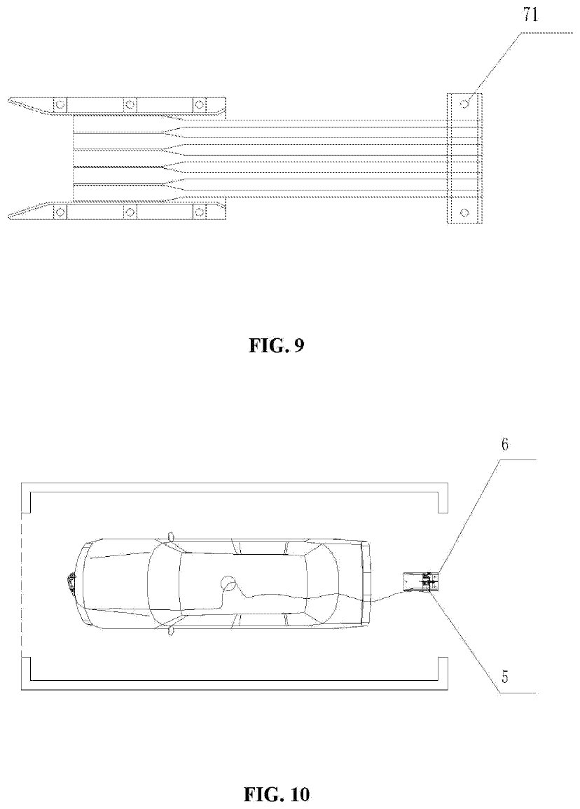

As shown in FIG. 1 to FIG. 9, this embodiment provides an apparatus for automatically charging a vehicle in an unmanned intelligent parking device, including a carrier 1 for a parking device, the carrier 1 being provided with a lifting component 2 and a traveling component 3; the apparatus further includes a charging docking apparatus 4, a charging adapter 5, a storage location charging fixing seat 6 and a storage location power pickup apparatus 7; the storage location charging fixing seat 6 is arranged in a parking space of the parking device, the carrier 1 is provided with the charging docking apparatus 4, the storage location power pickup apparatus 7 is mounted on the storage location charging fixing seat 6, and the charging adapter 5 is switched to the storage location charging fixing seat 6 through the charging docking apparatus 4 and electrically connected to the storage location power pickup apparatus 7. A vertical spring thrust shaft 56 clamps a vertical positioning pin 43, which can ensure that a charging gun 8 is always connected to a charging socket 53, and the charging docking apparatus 4 is always connected to the charging adapter 5 during the displacement and carrying of a vehicle. When the vehicle is carried to a parking space, the charging adapter 5 can be switched to the storage location charging fixing seat 6 through the charging docking apparatus 4, and is electrically connected to the storage location power pickup apparatus 7 to charge the vehicle.

In this embodiment, the charging adapter 5 includes a brush collector 51, a cable 52, a charging socket 53 and a mounting base 54; the brush collector 51 and the charging socket 53 are arranged on the mounting base 54, and the cable 52 is configured to connect the brush collector 51 to the charging socket 53. The brush collector 51 is configured to be directed into a collector rail 73 to pick up power from the collector rail 73; the mounting base 54 is made of nylon material to prevent electric leakage, and configured to mount the brush collector 51 and the charging socket 53; and the charging socket 53 is configured to hold an inserted vehicle charging gun.

In this embodiment, the storage location charging fixing seat 6 includes a horizontal positioning pin 62 and a fool-proof pin 63 that are mounted on a guide base 61; and the horizontal positioning pin 62 is inserted into the charging, adapter 5 and configured to position the charging adapter 5. The horizontal positioning pin 62 is configured to fix the charging adapter 5; the fool-proof pin 63 is eccentrically arranged, so that the charging adapter 5 can be fixed only in a correct direction, and a locking groove is provided so the charging adapter 5 can be removed only when unlocked; and the guide base 61 is fixed in a storage location with a bell mouth guide, so that the charging docking apparatus can be directed to a correct position.

In this embodiment, the charging adapter 5 is further provided with a horizontal spring thrust shaft 55, and the horizontal spring thrust shaft 55 is configured to clamp the fool-proof pin 63. More specifically, the horizontal spring thrust shaft 55 is configured to clamp the fool-proof pin 63 when the charging adapter 5 is arranged on the storage location charging fixing seat 6, so that the charging adapter 5 does not fall off the storage location charging fixing seat 6.

In this embodiment, the charging docking apparatus 4 includes a fixed outer frame 41, a rotating inner frame 42 and a vertical positioning pin 43 that are mounted on the carrier 1, a tail of the rotating inner frame 42 is connected to the fixed outer frame 41 through a rotating bearing set 44, a head thereof is provided with a universal bovine eye 45, a positioning guide wheel group 46 and the vertical positioning pin 43, and the universal bovine eye 45 longitudinally positions the rotating inner frame 42 in the guide base 61; and the positioning guide wheel group 46 is in contact with the charging adapter 5 and configured to longitudinally position the charging adapter 5 and the vertical positioning pin 43. More specifically, the fixed outer frame 41 is welded to a lifting frame of the canier 1 and configured to mount the charging docking apparatus 4. The rotating inner frame 42 is connected to the fixed outer frame 41 through the rotating bearing set 44, and can rotate around the rotating bearing set 44 serving as a fulcrum. The universal bovine eye 45 is configured to play a guiding role in a longitudinal direction when the charging docking apparatus 4 enters the storage location charging fixing seat 6, and play a guiding role in a vertical direction when the lifting frame of the carrier 1 moves upward. The rotating bearing set 44 is configured to fix the rotating inner frame 42, so that the rotating inner frame 42 and the fixed outer frame 41 can rotate by an appropriate angle. The positioning guide wheel group 46 is configured to correct a position of the charging adapter 5 when the charging docking apparatus 4 retrieves the charging adapter 5 from the storage location charging fixing seat 6, so that the vertical positioning pin 43 is exactly aligned with a pin hole in the charging adapter 5. Specifically, when the charging docking apparatus 4 retrieves the charging adapter 5 from the storage location charging fixing seat 6, the positioning guide wheel group 46 presses the charging adapter 5. Because the positioning guide wheel group 46 and the vertical positioning pin 43 are fixed, when the positioning guide wheel group 46 presses the charging adapter 5, the pin can be correctly inserted into the hole of the charging adapter 5. The vertical, positioning pin 43 is configured to fix the charging adapter 5.

In this embodiment, the apparatus for automatically charging a vehicle in an unmanned intelligent parking device further includes a stopping screw 47 and a guide spring 48, where the stopping screw 47 and the guide spring 48 are arranged between the fixed outer frame 41 and the rotating inner frame 42. The guide spring 48 has a damping effect on the rotating inner frame 42 and keeps the rotating inner frame 42 substantially in a centering position. The stopping screw 47 can adjust a rotating range of the rotating inner frame 42 to make the rotating inner frame 42 slightly rotate within a specified range.

In this embodiment, the storage location power pickup apparatus 7 includes a collector mounting base 71, and a collector rail seeker 72, a collector rail 73 and a power cord 74 that are mounted on the collector mounting base 71. The collector rail seeker 72 has a guiding function, so that the brush collector 51 can be smoothly directed into the collector rail 73. The power cord 74 is led out from a charging pile and connected to the collector rail 73.

In this embodiment, the charging adapter 5 is further provided with the vertical spring thrust shaft 56, and the vertical spring thrust shaft 56 clamps the vertical positioning pin 43, so that the charging docking apparatus 4 vertically positions the charging adapter 5. More specifically, when the charging adapter 5 is on the charging docking apparatus, the vertical spring thrust shaft 56 clamps the vertical positioning pin 43, so that the charging adapter 5 does not fall off the charging docking apparatus.

In this embodiment, the vertical positioning pin 43 pushes the horizontal spring thrust shaft 55 to be separated from the fool-proof pin 63, so that the charging adapter 5 is separated from the storage location charging fixing seat 6.

In this embodiment, a waterproof cover 57 is arranged outside a cable 52 of the charging adapter 5 to seal a welded end of the cable 52, so as to prevent snow water on a vehicle from dripping on the cable and causing electric leakage. A tail of the horizontal positioning pin 62 is provided with a compression spring 64 and an adjusting nut 65. The compression spring 64 is configured to absorb a positioning error when the charging adapter 5 is inserted; and the adjusting nut 65 is configured to adjust a position of the horizontal positioning pin 62 and fix the horizontal positioning pin 62.

Working principle:
I. A vehicle is stored in a garage for charging:

1. As shown in FIG. 10, a driver drives the vehicle to enter the garage from an entrance, inserts the charging adapter 5 into the storage location charging fixing seat 6 of the entrance, and inserts one end of the vehicle charging gun 8 into the vehicle and the other end into the charging socket 53 of the charging adapter 5. To prevent a charging cable from sagging, its middle part is fixed on a vehicle roof by using a magnet.

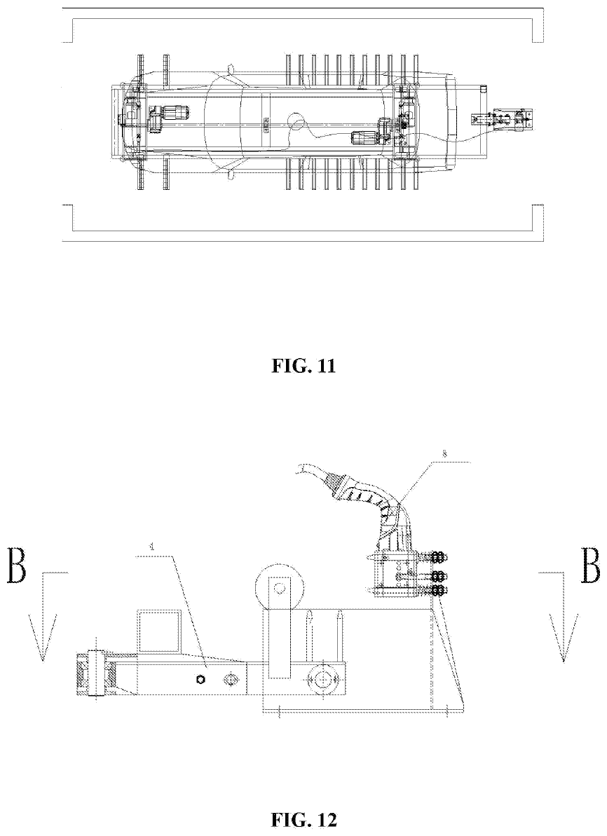

2. As shown in FIG. 11 the carrier 1 enters the entrance to carry the vehicle.

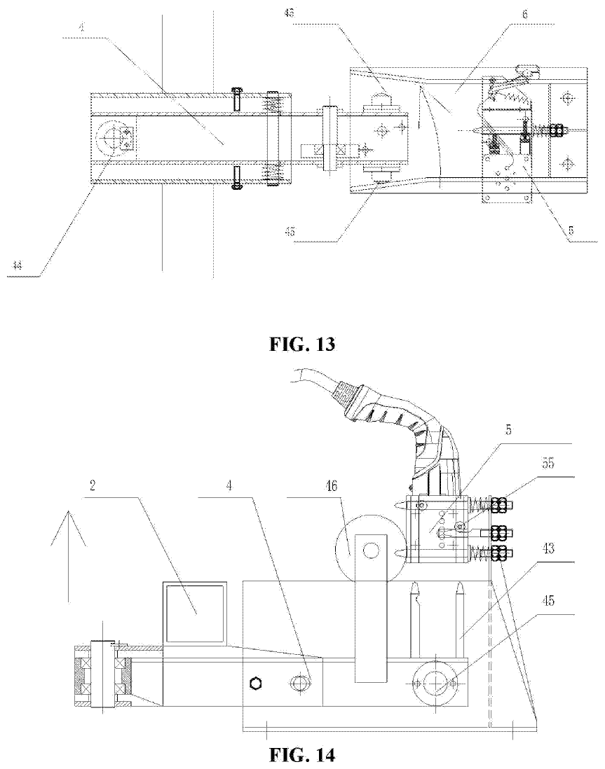

3. As shown in FIG. 12 and FIG. 13, the charging docking apparatus 4 is directed into a bell mouth of the storage location charging fixing seat 6 through the universal bovine eye 45 mounted thereon, and is aligned with the charging adapter 5. During direction, because the charging docking apparatus can rotate by a certain angle via the rotating bearing set 44, a direction position can be automatically adjusted to align the charging docking apparatus with the charging adapter 5.

4. As shown in FIG. 14, after the carrier 1 is in place, the positioning guide wheel, group 46 presses the charging adapter 5 for the charging adapter 5 to reach a correct position. The lifting component 2 of the carrier 1 lifts the vehicle and drives the charging docking apparatus 4 to lift. The vertical positioning pin 43 is inserted into the charging adapter 5. When the vertical positioning pin 43 is inserted into the charging adapter 5, the horizontal spring thrust shaft 55 is pushed and then unlocked. At this time, the universal bovine eye 45 can guide in a vertical direction.

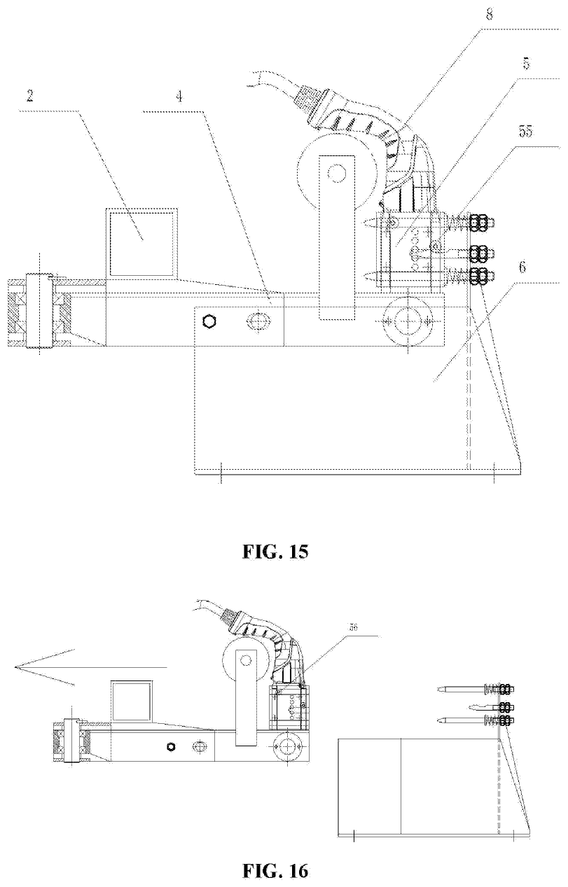

5. As shown in FIG. 15, after the lifting component 2 of the carrier rises in place, the carrier 1 moves backward. At this time, the horizontal spring thrust shaft 55 has been unlocked, and the charging adapter 5 is pulled out from the storage location charging fixing seat by the charging docking apparatus 4. At this time, the vehicle has been handed over to the carrier 1, and the charging adapter 5 and the charging gun are also handed over to the carrier 1.

6. As shown in FIG. 16, the carrier 1 carries the vehicle and the charging adapter 5 to leave the entrance and enters the storage location. During carrying, the vertical spring thrust shaft 56 locks the charging adapter 5 to ensure that the charging adapter 5 is not separated during carrying.

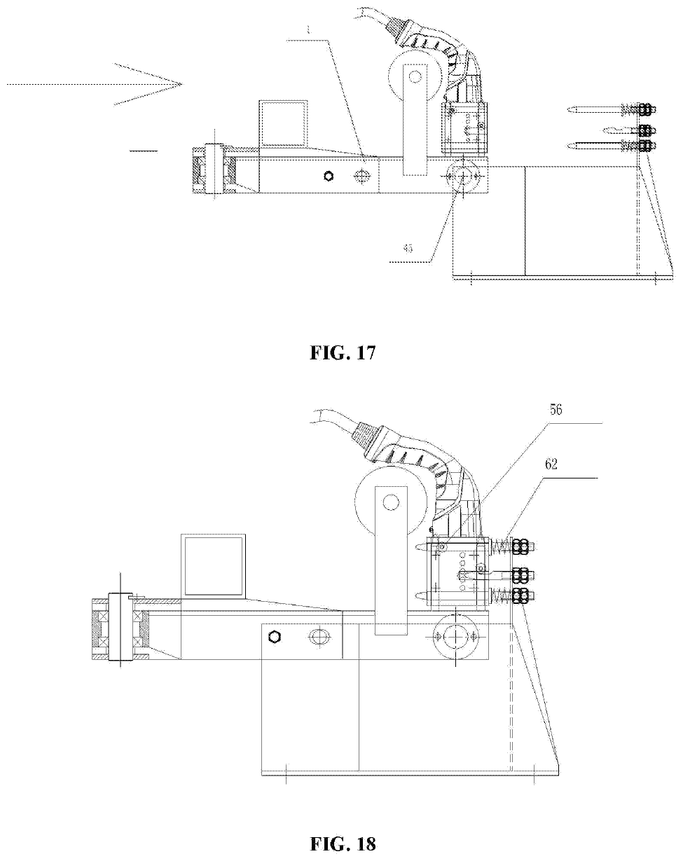

7. As shown in FIG. 17, when the carrier 1 transports the vehicle to the storage location, the charging docking apparatus 4 is directed into the bell mouth of the storage location charging fixing seat 6 through the universal bovine eye 45 mounted thereon. During direction, because the charging docking apparatus 4 can rotate by a certain angle via the rotating bearing set 44, a direction position can be automatically adjusted to align the charging adapter 5 with the horizontal positioning pin 62 of the storage location charging fixing seat 6.

8. As shown in FIG. 18, after getting in place, the horizontal positioning pin 62 is inserted into the charging adapter 5, and the brush collector 51 is directed into the collector rail 73. At this time, the vertical spring thrust shaft 56 is unlocked.

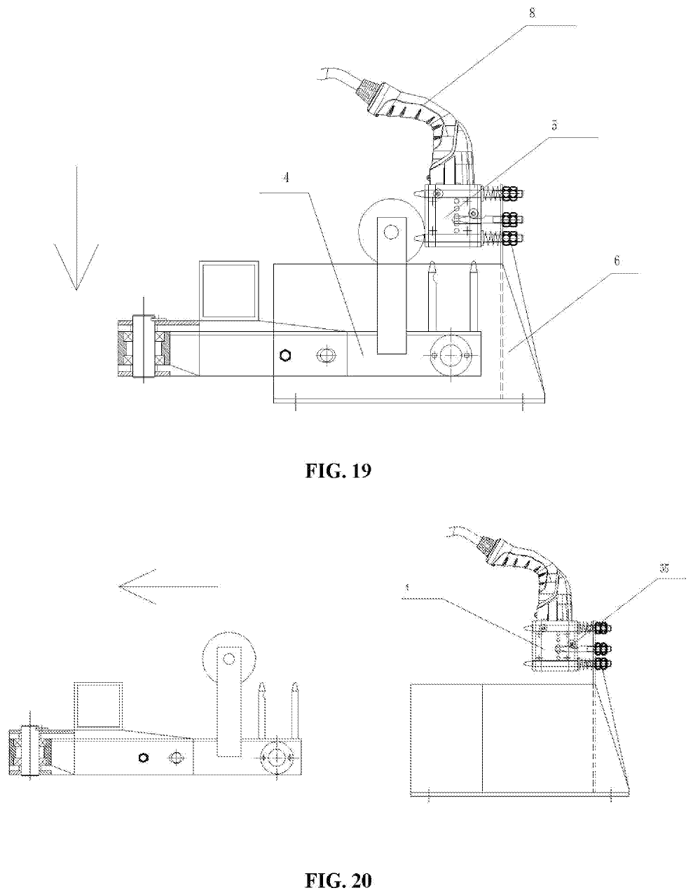

9. As shown in FIG. 19, after getting in place, the lifting component 2 on the carrier 1 descends to park the vehicle in the parking space. At this time, the charging docking apparatus 4 mounted on the lifting component 2 of the carrier 1 descends with the lifting component 2 of the carrier 1, leaving the charging adapter 5 and the charging gun on the storage location charging fixing seat 6.

10. As shown in FIG. 20, the carrier 1 leaves the storage location after storing the vehicle. At this time, the horizontal spring thrust shaft 55 locks the charging adapter 5, and after the positioning is detected, the charging pile transmits power. The automatic charging apparatus picks up power through the brush collector 51 and transmits the power to the charging gun to complete the charging of the vehicle.

II. A process of picking up and driving the vehicle out of the garage is similar to the above-mentioned garage entry process.

Although the embodiments of the present invention have been shown and described, it can be understood by a person of ordinary skill in the art that various changes, modifications, replacements and variations may be made to these embodiments without departing from the principles and spirit of the present invention.

What is claimed is:

1. An apparatus for automatically charging a vehicle in an unmanned intelligent parking device, comprising a carrier for a parking device, the carrier being provided with a lifting component and a traveling component, wherein the apparatus further comprises a charging docking apparatus, a charging adapter, a storage location charging fixing seat and a storage location power pickup apparatus; the storage location charging fixing, seat is arranged in a parking space of the parking device, the carrier is provided with the charging docking apparatus, the storage location power pickup apparatus is mounted on the storage location charging fixing seat, and the charging adapter is switched to the storage location charging fixing seat through the charging docking apparatus and electrically connected to the storage location power pickup apparatus.

2. The apparatus for automatically charging a vehicle in an unmanned intelligent parking device according to claim 1, wherein the charging adapter comprises a brush collector, a cable, a charging socket and a mounting base; the brush collector and the charging socket are arranged on the mounting base, and the cable is configured to connect the brush collector to the charging socket.

3. The apparatus for automatically charging a vehicle in an unmanned intelligent parking device according to claim 2, wherein the storage location charging fixing seat comprises a horizontal positioning pin and a fool-proof pin that are mounted on a guide base, and the fool-proof pin is eccentrically arranged; and the horizontal positioning pin is inserted into the charging adapter and configured to position the charging adapter.

4. The apparatus for automatically charging a vehicle in an unmanned intelligent parking device according to claim 3, wherein the charging adapter is further provided with a horizontal spring thrust shaft, and the horizontal spring thrust shaft is configured to clamp the fool-proof pin.

5. The apparatus for automatically charging a vehicle in an unmanned intelligent parking device according to claim 3, wherein the charging docking apparatus comprises a fixed outer frame, a rotating inner frame and a vertical positioning pin that are mounted on the carrier; a tail of the rotating inner frame is connected to the fixed outer frame through a rotating bearing set, a head thereof is provided with a universal bovine eye, a positioning guide wheel group and the vertical positioning pin, and the universal bovine eye longitudinally positions the rotating inner frame in the guide base; and the positioning guide wheel group is in contact with the charging adapter and configured to longitudinally position the charging adapter and the vertical positioning pin.

6. The apparatus for automatically charging a vehicle in an unmanned intelligent parking device according to claim 5, further comprising a stopping screw and a guide spring, wherein the stopping screw and the guide spring are arranged between the fixed outer frame and the rotating inner frame.

7. The apparatus for automatically charging a vehicle in an unmanned intelligent, parking device according to claim 1, wherein the storage location power pickup apparatus comprises a collector mounting base, and a collector rail seeker, a collector rail and a power cord that are mounted on the collector mounting base.

8. The apparatus for automatically charging a vehicle in an unmanned intelligent parking device according to claim 5, wherein the charging adapter is further provided with a vertical spring thrust shaft, and the vertical spring thrust shaft, clamps the vertical positioning pin, so that the charging docking apparatus vertically positions the charging adapter.

9. The apparatus for automatically charging a vehicle in an unmanned intelligent parking device according to claim 6, wherein the vertical positioning pin pushes the horizontal spring thrust shaft to be separated from the fool-proof pin, so that the charging adapter is separated from the storage location charging fixing seat.

10. The apparatus for automatically charging a vehicle in an unmanned intelligent parking device according to claim 3, wherein a waterproof cover is arranged outside a cable connection position of the charging adapter; and a tail of the horizontal positioning pin is provided with a compression spring and an adjusting nut.
